(19) United States
(12) Patent Application Publication
(10) Pub. No.: US 2023/0327912 A1
(43) Pub. Date: Oct. 12, 2023

(54) METHOD, DEVICE, GATEWAY, AND COMPUTER-READABLE MEDIUM FOR ROUTING PACKETS

(71) Applicant: ARRIS Enterprises LLC, Suwanee, GA (US)

(72) Inventor: Ju Li, Shenzhen, Guangdong (CN)

(21) Appl. No.: 18/023,117

(22) PCT Filed: Aug. 26, 2021
(86) PCT No.: PCT/US21/47689

§ 371 Date: Feb. 24, 2023

(30) Foreign Application Priority Data
Sep. 2, 2020 (CN) 202010909379.3

(51) Int. Cl. H04L 12/46; H04L 41/0654

(52) U.S. Cl. CPC H04L 12/4633; H04L 41/0654

(57) ABSTRACT

The present disclosure relates to the routing packets. A gateway establishes a DS-Lite tunnel with an AFTR device to work in a first mode. The gateway uses the DS-Lite tunnel to route IPv4 packets for IPv4 client devices in the first mode, and uses its IPv4 public network address to route IPv4 packets for IPv4 client devices in the second mode. In response to determining that the DS-Lite tunnel is unavailable, the gateway switches from the working mode in the first mode to the second mode. By switching the working mode, it is possible to continue to provide network services for IPv4 client devices without manual assistance and quickly alleviate the problem of DS-Lite tunnel failure.

### TECHNICAL FIELD

The present disclosure relates to the field of communication networks, and more specifically, to a method, a device, a gateway, and a computer-readable medium for routing packets in the field of communication networks.

### BACKGROUND ART

With the development of the Internet, IPv4 (Internet Protocol Version 4) public network addresses have been gradually exhausted, making it difficult to deploy new routing devices, servers, and other network devices. This severely restricts the development of IP (Internet Protocol) networks. In order to overcome the problem of insufficient IPv4 public network addresses, technicians are studying IPv6 (Internet Protocol Version 6) technology. IPv6 technology uses a longer network address than IPv4 address, and thus IPv6 can allocate a unique network address for almost all objects on the earth.

IPv4 protocol and IPv6 protocol are two different protocol types, corresponding to different protocol stacks. Devices that support one of them cannot communicate under the other protocol. Most of the existing IP networks are IPv4 networks, and there are a large number of devices that support the IPv4 protocol. Although IPv6 technology has developed significantly in recent years and there have been IPv6 networks and corresponding IPv6 devices with faster transmission speeds and better network service quality, IPv4 networks and IPv6 networks, as well as IPv4 devices and IPv6 devices will coexist for a long time.

In the present specification, client devices/servers/apparatus that only support IPv4 protocol will be referred to as IPv4 client devices/servers/apparatus, client devices/servers/apparatus that only support IPv6 protocol will be referred to as IPv6 client devices/servers/apparatus, and client devices/servers/apparatus that support both IPv6 protocol and IPv4 protocol will be referred to as dual stack client devices/servers/apparatus. Devices that support the same network layer protocol can communicate with each other. However, the devices that support the same network layer protocol may be separated by networks with different network layer protocols, making it difficult for them to communicate across different networks. For example, when there is at least one IPv6 network between two IPv4 devices, it is difficult for an IPv4 packet which is to be transferred between the two IPv4 devices to be transmitted across the IPv6 network.

In order to enable an IPv4 device to communicate with another IPv4 device across an IPv6 network, DS-Lite (Dual Stack Lite) technology is introduced. The DS-Lite technology can route IPv4 packets on the IPv6 network by using a DS-Lite tunnel established between a gateway on the client device side and an AFTR (Address Family Transition Router) device on the network side, thereby enabling an IPv4 device to access a remote IPv4 device across the IPv6 network.

Due to the introduction of the DS-Lite technology, a gateway with a LAN (Local Area Network) interface on the client device side can usually work in one of three modes. The three modes include an IPv4 only mode, an IPv6+DS-Lite mode, and a dual stack mode. In the IPv4 only mode, the external network side interface of the gateway (for example, a WAN (Wide Area Network) interface) has an IPv4 public network address, and can directly route IPv4 packets on the IPv4 network. In the dual stack mode, the WAN interface of the gateway has an IPv4 public network address and an IPv6 public network address, and thus can route IPv4 packets on the IPv4 network and route IPv6 packets on the IPv6 network. In the IPv6+DS-Lite mode, the WAN interface of the gateway only has an IPv6 public network address, and a DS-Lite tunnel is established with the AFTR device in the IPv6 network. Through the DS-Lite tunnel, it is possible to route IPv4 packets in the IPv6 network, so that IPv4 devices can communicate across the IPv6 network. The gateway and the AFTR device at two ends of the DS-Lite tunnel can implement the transmission of IPv4 packets in the IPv6 network by adding IPv6 headers to IPv4 packets and removing IPv6 headers from IPv6 packets. Since the gateway only has an IPv6 public network address in the IPv6+DS-Lite mode, an IPv4 address can be saved, which alleviates the problem of IPv4 address shortage.

However, the DS-Lite tunnel may fail due to various reasons, making it difficult to route any IPv4 packet in the IPv6 network, resulting in that an IPv4 client device connected to the gateway cannot receive Internet services. When a failure occurs in the DS-Lite tunnel, a usual approach is to seek the help of network maintenance personnel and ask them to manually solve the problem of DS-Lite tunnel failure. This would take a lot of time and make users disconnected for too long, which greatly lowers network service performance and user experience.

Therefore, it is desirable to provide a way to automatically solve the aforementioned problem caused by DS-Lite tunnel failure.

### SUMMARY OF THE INVENTION

Some aspects of the present disclosure relate to a gateway for routing packets. The gateway may include: a memory, in which an instruction is stored; and a processor, configured to execute the instruction stored in the memory to cause the gateway to execute the following operations. The operations include: establishing a DS-Lite tunnel with an AFTR device to work in a first mode, wherein the gateway can work in a working mode including a first mode and a second mode, the gateway uses the DS-Lite tunnel to route IPv4 packets for IPv4 client devices in the first mode, and the gateway uses its IPv4 public network address to route IPv4 packets for IPv4 client devices in the second mode; and in response to determining that the DS-Lite tunnel is unavailable, switching the working mode from the first mode to the second mode.

In some embodiments, in the process of switching the working mode from the first mode to the second mode, the gateway may request an IPv4 public network address from the network side, and route IPv4 packets for IPv4 client devices using an IPv4 public network address allocated by the network side.

In some embodiments, the gateway may periodically detect whether the unavailable DS-Lite tunnel is restored to be available, and switch the working mode from the second mode to the first mode when the DS-Lite tunnel is restored to be available.

In some embodiments, the gateway may release the IPv4 public network address used in the second mode after switching the working mode from the second mode to the first mode.

In some embodiments, the gateway may determine that the DS-Lite tunnel is unavailable based on determining that the establishment of the DS-Lite tunnel fails.

In some embodiments, the gateway may determine that the DS-Lite tunnel is unavailable based on not receiving a packet from the AFTR device within a predetermined time.

Other aspects of the present disclosure relate to a method, a device, and a non-transitory computer-readable medium for routing packets. They all can achieve the operations that can be executed by the gateway.

### BRIEF DESCRIPTION OF THE DRAWINGS

For a better understanding of the present disclosure and to show how to implement the present disclosure, description will be made with reference to the attached drawings by way of examples, wherein:

FIG. 1 is a schematic diagram of a network implementing DS-Lite technology according to an embodiment of the present disclosure.

FIG. 2 is an exemplary configuration block diagram of the gateway in FIG. 1 according to an embodiment of the present disclosure.

FIG. 3 is a flowchart of a method for routing packets according to an embodiment of the present disclosure.

FIG. 4 is a flowchart of another method for routing packets according to an embodiment of the present disclosure.

FIG. 5 is a flowchart of a method for routing packets in a case where the establishment of a DS-Lite tunnel fails according to an embodiment of the present disclosure.

FIG. 6 is a flowchart of a method for routing packets in a case where a DS-Lite tunnel fails during use according to an embodiment of the present disclosure.

### DESCRIPTION OF EMBODIMENTS

The following detailed description is made with reference to the attached drawings, and the following detailed description is provided to facilitate comprehensive understanding of various exemplary embodiments of the present disclosure. The following description includes various details to facilitate understanding. However, these details are merely considered as examples, not for limiting the present disclosure. The present disclosure is defined by the appended claims and their equivalents. The words and phrases used in the following description are only used to enable a clear and consistent understanding of the present disclosure. In addition, for clarity and brevity, descriptions of well-known structures, functions, and configurations may be omitted. Those of ordinary skill in the art will realize that various changes and modifications can be made to the examples described in the present specification without departing from the gist and scope of the present disclosure.

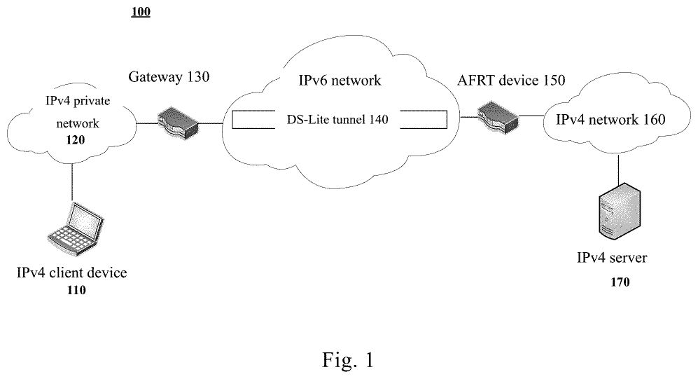

First, reference is made to FIG. 1, which is a schematic diagram of a network 100 using DS-Lite technology according to an embodiment of the present disclosure.

In the network 100, an IPv4 client device 110 can be connected to a gateway 130 on the client device side through an IPv4 private network 120. The IPv4 client device 110 may be a desktop computer, a notebook computer, a tablet computer, a smart phone, a smart home appliance, or other Internet-enabled information processing devices. The gateway 130 may be an access point, a router, a B4 (Basic Bridging Broadband) device, or other Internet access devices that support DS-Lite technology.

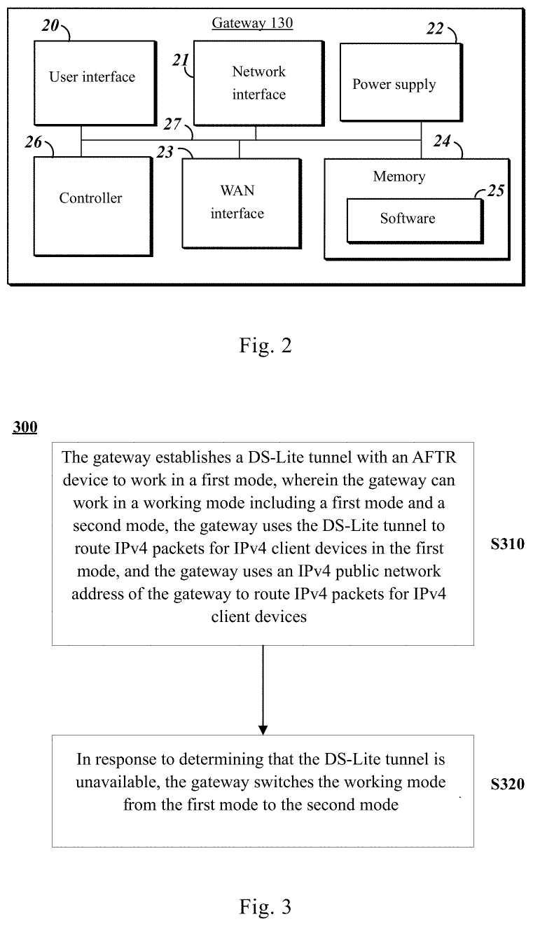

FIG. 2 shows an exemplary configuration block diagram of the gateway 130 according to an embodiment of the present disclosure.

Although it is referred to as a gateway herein, the gateway 130 may be, for example, a hardware electronic device that can combine the functions of a modern, an access point, and/or a router. The present disclosure further proposes that the gateway 130 may include, but is not limited to, functions of a smart media device (SMD) or an IP/QAM set top box (STB) that can decode audio/video contents and play contents provided by OTT or MSO.

As shown in FIG. 2, the gateway 130 includes a user interface 20, a network interface (for example, a LAN interface) 21, a power supply 22, a WAN interface 23, a memory 24, and a controller 26. The user interface 20 may include, but is not limited to, a button, a keyboard, a keypad, LCD, CRT, TFT, LED, HD or other similar display devices, including a display device with a touch screen capability that enables interaction between a user and the gateway 130. The network interface 21 may comprise various types of network cards and circuit systems implemented by software and/or hardware so as to be able to communicate with a wireless extender device and a client device using one or more wireless protocols. The wireless protocol is, for example, any IEEE 802.11 Wi-Fi protocol, Bluetooth protocol, Bluetooth Low Energy (BLE) or other short-distance protocols operated in accordance with wireless technology standards to use any licensed or unlicensed frequency band (for example, the Citizen Broadband Radio Service (CBRS) band, 2.4 GHz band, 5 GHz band, or 6 GHz band), RF4CE protocol, ZigBee protocol, Z-Wave protocol, or IEEE 802.15.4 protocol to exchange data over a short distance.

The power supply 22 provides power to internal components of the gateway 130 via an internal bus 27. The power supply 22 may be a self-contained power source such as a battery pack, and it has an interface which is powered by (for example, directly or through other devices) an electrical charger connected to a socket. The power supply 22 may further include a rechargeable battery that is detachable for replacement, for example, NiCd, NiMH, Li ion or Li polymer battery. When the gateway 130 is a modem or a gateway device, it may include the WAN interface 23. The WAN interface 23 may include various network cards and circuits implemented by software and/or hardware so as to achieve the communication between the gateway device and an Internet service provider or a multi-system operator (MSO).

The memory 24 includes a single memory or one or more memories or storage locations, including but not limited to a random access memory (RAM), a dynamic random access memory (DRAM), a static random access memory (SRAM), a read-only memory (ROM), EPROM, EEPROM, ROM, a flash memory, FPGA logic block, a hard disk, or any other layers of a memory hierarchy. The memory 24 may be used to store any type of instructions, software or algorithms, including software 25 for controlling general functions and operations of the gateway 130.

The controller 26 controls the general operations of the gateway 130 and executes the administrative functions related to other devices in the network (for example, extenders and client devices). The controller 26 may include, but is not limited to, a CPU, a hardware microprocessor, a hardware processor, a multi-core processor, a single-core processor, a microcontroller, an application-specific integrated circuit (ASIC), a DSP, or other similar processing devices, which can execute any type of instructions, algorithms, or software for controlling the operations and functions of the AP 110 according to the embodiments described in the present disclosure. The processor 26 may be various implementations of a digital circuit system, an analog circuit system, or a mixed signal (combination of analog and digital) circuit system that executes functions in a computing system. The controller 26 may comprise, for example, a circuit such as an integrated circuit (IC), a portion or circuit of a separate processor core, an entire processor core, a separate processor, a programmable hardware device such as a field programmable gate array (FPGA), and/or a system comprising a plurality of processors.

The internal bus 27 may be used to establish communication between the components of the gateway 130 (for example, 20 to 22, 24, and 26).

Returning to FIG. 1, the gateway 130 is connected to an IPv6 network through the WAN interface with an IPv6 address, and establishes a DS-Lite tunnel 140 (may also be referred to as an IPv4 over IPv6 tunnel) with an AFTR device 150 on the IPv6 network. After receiving IPv4 packets sent from an IPv4 client device through the LAN interface of the gateway 130, the gateway 130 can convert the IPv4 packets into IPv6 packets that can be sent to the AFTR device 150 via the IPv6 network by performing existing operations such as adding IPv6 headers and address mapping on the IPv4 packets, and transmit the IPv6 packets from the WAN interface of the gateway 130 to the AFTR device 150 through the DS-Lite tunnel 140. The AFTR device 150 can obtain IPv4 packets by performing existing operations such as decapsulation and address mapping on the IPv6 packets, and transmit the IPv4 packets through an IPv4 network 160 to an IPv4 server 170 that the IPv4 client device 110 wants to access.

Conversely, the IPv4 packets that the IPv4 server 170 attempts to send to the IPv4 client device 110 first reaches the AFTR device 150 via the IPv4 network 160. The AFTR device 150 can convert the IPv4 packets into IPv6 packets to be sent to the gateway 130 via the IPv6 network by performing existing operations such as adding IPv6 headers and address mapping on the IPv4 packets, and send the IPv6 packets to the gateway 130 through the DS-Lite tunnel 140. The gateway 130 can obtain the IPv4 packets to be sent to the IPv4 client device 110 by performing existing operations such as decapsulation and address mapping on the received IPv6 packets, and send the IPv4 packets to the IPv4 client device 110 through the IPv4 private network 120.

The LAN interface of the gateway 130 connected to the IPv4 private network 120 may have an IPv4 private address, so that it can communicate with the IPv4 client device 110 having a different IPv4 private address on the IPv4 private network. The external WAN interface of the gateway 130 may have an IPv6 public network address, so that IPv6 packets can be transmitted through the IPv6 network, and IPv4 packets can be transmitted on the IPv6 network via the DS-Lite tunnel. Since the gateway 130 can route IPv4 packets 10 through the DS-Lite tunnel without an IPv4 public network address, the IPv4 public network address is not necessary for the gateway 130, and the IPv4 address space can be saved as a result.

Although not shown in FIG. 1, those of ordinary skill in the art can understand that the gateway 130 may also be connected to an IPv6 local area network through other LAN interfaces to provide Internet services for IPv6 client devices. The IPv6 packets received by the gateway 130 from the IPv6 client device may be directly sent to the IPv6 network through the WAN interface of the gateway 130 so as to access the IPv6 device without passing through the AFTR device 150.

When a failure occurs in the DS-Lite tunnel 140 and the DS-Lite tunnel 40 becomes unavailable, the gateway 130 will not be able to route IPv4 packets on the IPv6 network for the IPv4 client device 110, and as a result, the IPv4 client device 110 cannot receive Internet services.

In order to automatically solve this problem to avoid reduced network service performance and user experience, a method 300 for routing packets according to an embodiment of the present disclosure shown in FIG. 3 may be executed. In the description of the method 300, a detailed description will be made with reference to the network 100 shown in FIG. 1.

In S310, the gateway establishes a DS-Lite tunnel with the AFTR device to work in a first mode. The gateway has plural working modes, including a first mode and a second mode. In the first mode, the gateway uses the DS-Lite tunnel to route IPv4 packets for IPv4 client devices, and in the second mode, the gateway uses the IPv4 public network address of the gateway to route IPv4 packets for IPv4 client devices.

For example, the gateway 130 may establish the DS-Lite tunnel 140 with the AFTR device 150 by using the existing DS-Lite technology, thereby attempting to operate in the first mode such as the IPv6+DS-Lite mode. In the first mode, the gateway 130 may have an IPv6 address only without having an IPv4 public network address, so that IPv4 packets can be routed through the DS-Lite tunnel 140, and the IPv4 address space can be saved; moreover, the service to IPv6 client devices will not be affected.

In S320, in response to determining that the DS-Lite tunnel in S310 is unavailable, the gateway switches the working mode from the first mode to the second mode.

According to an embodiment of the present disclosure, the gateway 130 may find that the DS-Lite tunnel is not successfully established in the process of establishing the DS-Lite tunnel, and thus determine that the DS-Lite tunnel is unavailable. For example, the gateway 130 may use the domain name of the AFTR server 150 to query a DNS (Domain Name Server) server for the IPv6 address of the AFTR server 150. However, due to timeout, packet loss and other reasons, the gateway 130 may fail to receive the IPv6 address of the AFTR server 150 from the DNS server, and thus the DS-Lite tunnel cannot be established. Alternatively, during the startup of the gateway 130, due to timing errors in the DS-Lite tunnel establishment process and other processes, the DS-Lite tunnel establishment process cannot continue, and an error occurs in the parameters related to the DS-Lite tunnel. As a result, the gateway 130 may determine that the establishment of the DS-Lite tunnel fails.

According to an embodiment of the present disclosure, the gateway 130 may also determine that the DS-Lite tunnel is unavailable based on not receiving a message from the AFTR device 150 within a predetermined time. For example, the gateway 130 may send to the AFTR device 150 a certain packet which requires a response from the AFTR device 150, and determine that a failure occurs in the DS-Lite tunnel when not receiving a packet returned by the AFTR device 150 in response to the packet within a predetermined time (for example, 1 minute, 3 minutes, 5 minutes, 10 minutes, etc.). Or, there is data transmission between the gateway 130 and the AFTR device 150, but no new packet has been received after a predetermined time (for example, 10 minutes, 20 minutes, etc.) since the last time a packet was received from the AFTR device 150, then it is determined that a failure occurs in the DS-Lite tunnel, and this may be caused by factors such as that the AFTR device 150 malfunctions and cannot work normally.

When the DS-Lite tunnel fails and cannot be used, in order to continue to provide routing services to the IPv4 client device 110, the gateway 130 may switch from the first mode such as the IPv6+DS-Lite mode to the second mode such as the dual stack mode.

For example, the gateway 130 may request an IPv4 public network address from the network side. After receiving the IPv4 public network address allocated by the network side, the gateway 130 may route IPv4 packets for the IPv4 client device through the IPv4 public network address. For example, when the gateway 130 is a cable modem, its corresponding terminal device is CMTS (Cable Modem Terminal System). In response to the message sent by the cable modern requesting the allocation of an IPv4 public network address, the CMTS may select an address from the free IPv4 public network address space and allocate it to the gateway 130, so that the gateway 130 can directly route IPv4 packets through the WAN interface with the address.

In the second mode, the gateway 130 may have not only an IPv4 public network address to route IPv4 packets but also an IPv6 public network address to route IPv6 packets. The DS-Lite tunnel 140 is not needed for the routing of these packets.

According to the above technical solution, when the gateway determines that the DS-Lite tunnel is unavailable, the gateway may automatically switch from the current first mode in which the DS-Lite tunnel is used to route IPv4 packets to the second mode in which the IPv4 public network address of the gateway is used to route IPv4 packets. By switching the working mode, it is possible to continue to provide network services for IPv4 client devices without manual assistance and quickly alleviate the problem of being unable to route IPv4 packets caused by DS-Lite tunnel failure, thereby improving network service performance and user experience.

Comparing with the conventional technology where it takes a lot of time to manually deal with the problem of tunnel failure to continue to provide routing services for IPv4 packets, the method of the embodiment of the present disclosure relies on automatic switching of the working mode by the gateway 130, which only takes about 2 minutes to quickly restore the routing of IPv4 packets. This greatly avoids the adverse impact of tunnel failure on the network services of IPv4 client devices.

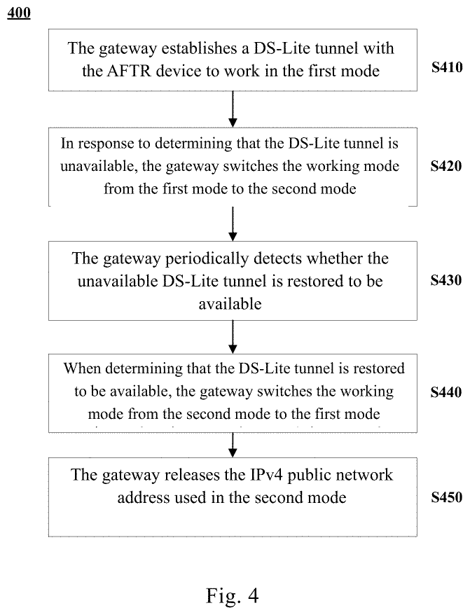

FIG. 4 shows a flowchart of another method 400 for routing packets according to an embodiment of the present disclosure. S410 and S420 in the method 400 are basically the same as S310 and S320 in the method 300, and thus will not be repeated here. The difference between the methods 400 and 300 is that the gateway 130 will further detect whether the unavailable DS-Lite tunnel is restored to be available, and take further actions if it is restored to be available. In the description of the method 400, a detailed description is still made with reference to the schematic diagram of FIG. 1.

In S430, the gateway 130 periodically detects whether the unavailable DS-Lite tunnel 140 is restored to be available.

For example, the gateway 130 may periodically send a message through the DS-Lite tunnel 140 to the AFTR device 150 requesting a response from the AFTR device 150, and determine that the DS-Lite tunnel 140 which had a failure is restored to be available after receiving the response from the AFTR device 150. This may be a result of the fact that the gateway 130 periodically restarts the DS-Lite tunnel establishment process and successfully establishes the DS-Lite tunnel, or it may be a result of the fact that the AFTR device 150 returns to normal operation, etc.

In S440, when the gateway 130 determines that the DS-Lite tunnel 140 is restored to be available, the gateway 130 switches the working mode from the second mode to the first mode.

When the DS-Lite tunnel 140 is restored to be available, the gateway 130 may route IPv4 packets through the DS-Lite technology to provide routing services for IPv4 client devices. Therefore, the gateway 130 can switch from the second mode such as the dual stack mode to the first mode such as the IPv6+DS-Lite mode.

In S450, the gateway 130 releases the IPv4 public network address used in the second mode.

In the case where the gateway 130 in the first mode can route IPv4 packets through the DS-Lite tunnel, the IPv4 public network address is no longer necessary for the gateway 130. Therefore, in order to save the limited IPv4 address space, the gateway 130 may send a message to the network side to indicate that the IPv4 public network address that the gateway 130 used in the second mode is no longer needed, thereby instructing the network side to allocate the IPv4 public network address to other devices as needed. Alternatively, the network side may, upon detecting that the IPv4 public network address allocated to the gateway 130 has not been used within a predetermined time, determine that the gateway 130 has released the address, and thus may allocate the address to other devices.

Through the allocation and release of the IPv4 public network address, it is possible to increase the efficiency of the use of the IPv4 public network address, so that it is possible to deal with the problem of being unable to route IPv4 packets due to the DS-Lite tunnel failure by using the IPv4 public network address, and it is also possible to avoid the invalid occupation of the IPv4 public network address.

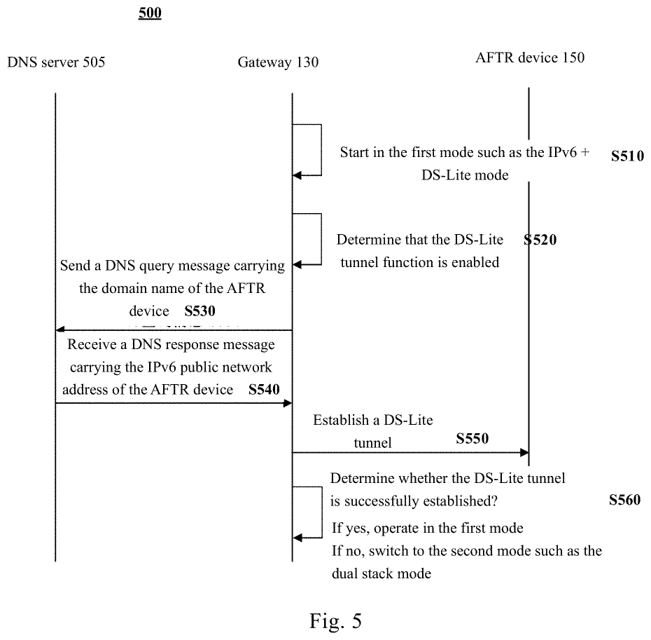

In FIG. 5, a flowchart of a method 500 for routing packets according an embodiment of the present disclosure is described with an example of failure to establish the DS-Lite tunnel.

In S510, the gateway 130 starts in the first mode such as the IPv6+DS-Lite mode. The startup of the mode may be achieved by setting a startup mode in a configuration file by a system operator. In the first mode, the gateway 130 may route IPv6 packets through its own IPv6 public network address and route IPv4 packets through the DS-Lite tunnel without an IPv4 public network address.

In S520, the gateway 130 determines that the DS-Lite tunnel function is enabled.

In S530, the gateway 130 sends a DNS query message which carries the domain name of the AFTR device 150 to a DNS server 505 to request the IPv6 public network address of the AFTR device 150.

In S540, the gateway 130 receives a DNS response message sent from the DNS server 505, which carries the IPv6 public network address of the AFTR device 150.

In S550, the gateway 130 establishes a DS-Lite tunnel with the AFTR device 150 based on the IPv6 public network address of the AFTR device 150.

In the process of establishing the DS-Lite tunnel, the DS-Lite tunnel may not be successfully established due to the fact that the gateway 130 has a timing error when executing its own the process, or the fact that the AFTR device fails to correctly respond to an establishment request, etc. It is also possible that the gateway 130 fails to receive a DNS response message from the DNS server 505 due to timeout, packet loss, or other reasons in S540, and thus cannot know the IPv6 public network address of the AFTR device 150, causing S550 not to be executed. This also results in the DS-Lite tunnel establishment failure.

In S560, the gateway 130 determines whether the DS-Lite tunnel is successfully established. For example, the gateway may determine whether the DS-Lite tunnel is successfully established by querying the process parameters related to the status of the DS-Lite tunnel. For example, when the parameter Device.DSLite.Enable related to starting the DS-Lite tunnel function is true and the parameter Device.DSLite.InterfacesSettings.1.Status related to the status of the DS-Lite tunnel is false, it is determined that the establishment of the DS-Lite tunnel fails.

When the DS-Lite tunnel is successfully established, the gateway 130 works in the first mode.

On the contrary, when the DS-Lite tunnel is not successfully established, the gateway 130 switches from the first mode to the second mode such as the dual stack mode, thereby routing IPv4 packets through the IPv4 public network address obtained from the network side and routing IPv6 packets through its own IPv6 public network address.

Then, the gateway 130 may detect whether the DS-Lite tunnel is restored to be available. When the DS-Lite tunnel is restored to be available, the gateway 130 may switch from the second mode to the first mode and may release the IPv4 public network address, thereby saving IPv4 address space.

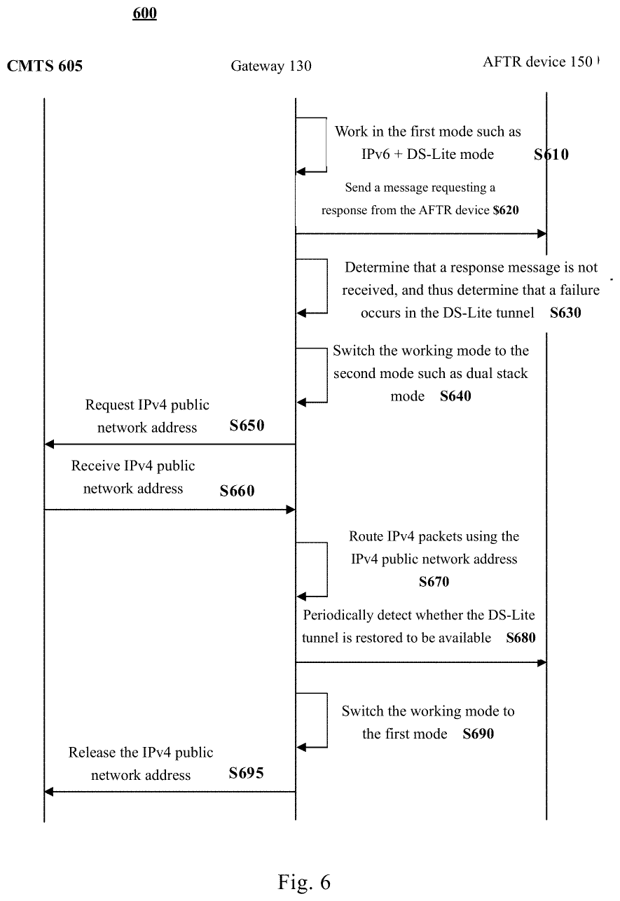

In FIG. 6, a flowchart of a method 600 for routing packets according to an embodiment of the present disclosure is described with an example in which a failure occurs in the DS-Lite tunnel during use.

In S610, the gateway 130 works in the first mode such as the IPv6+DS-Lite mode. In this case, the gateway only has an IPv6 public network address and routes IPv4 packets through the DS-Lite tunnel 140 of the AFTR device 150. The IPv4 client device 110 can communicate with the IPv4 server 170 across the IPv6 network through the DS-Lite tunnel 140 between the gateway 130 and the AFTR device 150.

In S620, the gateway 130 sends a message through the DS-Lite tunnel 140 to the AFTR device 150 requesting a response from the AFTR device 150. For example, the gateway 130 may add a flag bit that requests the AFTR device 150 to respond into the IPv6 header in which an IPv4 packet is encapsulated. Upon detecting the flag bit, the AFTR device 150 transmits a response message to the gateway 130.

In S630, the gateway 130 determines that the response message from the AFTR device 150 is not received, and thus determines that a failure occurs in the DS-Lite tunnel 140.

In S640, the gateway 130 switches the working mode from the first mode to the second mode such as the dual stack mode.

In S650, the gateway 130 requests an IPv4 public network address from the CMTS 605 as the terminal device of the network service provider network.

In S660, the gateway 130 receives an IPv4 public network address sent from the CMTS 605.

In S670, the gateway 130 routes IPv4 packets using the IPv4 public network address, and thus can still provide IPv4 routing services when the DS-Lite tunnel is unavailable.

In S680, the gateway 130 periodically detects whether the DS-Lite tunnel is restored to be available. For example, the gateway 130 may periodically restart the process of establishing a DS-Lite tunnel with the AFTR device 150. Alternatively, the gateway 130 may periodically send a message to the AFTR device 150 requesting a response from the AFTR device 150.

In S690, upon determining that the DS-Lite tunnel is restored to be available, the gateway 130 switches the working mode from the second mode to the first mode.

In S695, the gateway 130 releases the IPv4 public network address that the gateway 130 used in the second mode. For example, the gateway 130 may send a message to inform the CMTS 605 that the gateway 130 no longer uses the IPv4 public network address allocated to the gateway 130.

By executing the aforementioned method, whenever a failure occurs in the DS-Lite tunnel, the gateway can, by switching the working mode, continue to provide network services for IPv4 client devices without manual assistance and quickly alleviate the problem of being unable to route IPv4 packets due to the DS-Lite tunnel failure, thereby improving network service performance and user experience. When the DS-Lite tunnel is restored to be available, the gateway can release the IPv4 public network address by further switching the working mode, thereby saving the IPv4 address space and improving the use efficiency of the IPv4 public network address.

The present disclosure can be implemented as any combination of devices, systems, integrated circuits, and computer programs on non-transitory computer-readable media. One or more processors can be implemented as an integrated circuit (IC), an application specific integrated circuit (ASIC) or a large-scale integrated circuit (LSI), a system LSI, or a super LSI or super LSI component that performs part or all of the functions described in this disclosure.

The present disclosure includes the use of software, applications, computer programs, or algorithms. Software, application programs, computer programs or algorithms can be stored on a non-transitory computer readable medium, so that a computer with one or more processors can execute the above steps and the steps described in the drawings. For example, one or more memories store software or algorithms via executable instructions, and one or more processors may associate a set of instructions executing the software or algorithms to avoid the problem of being unable to route IPv4 packets caused by DS-Lite tunnel failure in any number of wireless networks according to the embodiments described in the present disclosure.

Software and computer programs (may also be referred to as programs, software applications, applications, components, or codes) include machine instructions for programmable processors, and can be realized in high-level procedural languages, object-oriented programming languages, functional programming languages, logic programming languages, or assembly languages or machine languages. The term “computer-readable medium” refers to any computer program product, device or apparatus used to provide machine instructions or data to a programmable data processor, such as magnetic disks, optical disks, solid-state storage devices, memories, and programmable logic devices (PLDs), including computer-readable media that receive machine instructions as computer-readable signals.

For example, the computer-readable medium may include dynamic random access memory (DRAM), random access memory (RAM), read-only memory (ROM), electrically erasable read-only memory (EEPROM), compact disk read-only memory (CD-ROM) or other optical disk storage devices, magnetic disk storage devices or other magnetic storage devices, or any other medium that can be used to carry or store required computer-readable program codes in the form of instructions or data structures and that can be accessed by a general-purpose or special-purpose computer or a general-purpose or special-purpose processor. As used herein, magnetic disks or disks include compact discs (CDs), laser disks, optical disks, digital versatile discs (DVDs), floppy disks, and Blu-ray disks, where magnetic disks usually copy data magnetically, and disks use laser to optically copy data. Combinations of the above also fall into the scope of computer-readable media.

In one or more embodiments, the use of the words “able”, “can”, “operable as” or “configured as” refers to some devices, logics, hardware and/or components designed to be used in a specified manner. The subject matter of the present disclosure is provided as an example of the apparatus, system, method, and program for performing the features described in the present disclosure. However, in addition to the above-mentioned features, other features or modifications can be expected. It is expected that any newly emerging technology that may replace any of the above-mentioned implementation technologies can be used to complete the implementation of the components and functions of the present disclosure.

In addition, the above description provides examples without limiting the scope, applicability, or configuration set forth in the claims. Without departing from the spirit and scope of the present disclosure, changes may be made to the function and arrangement of the discussed elements. Various processes or components may be omitted, substituted, or added in the embodiments as appropriate. For example, features described with respect to some embodiments may be combined in other embodiments.

Similarly, although operations are depicted in a specific order in the drawings, this should not be understood as requiring such operations to be performed in the specific order shown or in a sequential order, or requiring the performance of all illustrated operations to achieve the desired result. In some cases, multi-tasking and parallel processing can be advantageous.

1. A gateway for routing packets, including:
a memory, in which an instruction is stored; and
a processor, configured to execute the instruction stored in the memory to cause the gateway to execute the following operations:
establishing a DS-Lite tunnel with an AFTR device to work in a first mode, wherein the gateway can work in a working mode including a first mode and a second mode, the gateway uses the DS-Lite tunnel to route IPv4 packets for IPv4 client devices in the first mode, and the gateway uses its IPv4 public network address to route IPv4 packets for IPv4 client devices in the second mode; and
in response to determining that the DS-Lite tunnel is unavailable, switching the working mode from the first mode to the second mode.

2. The gateway according to claim 1, wherein the processor is further configured to execute the instruction stored in the memory to cause the gateway to execute the following operations:
requesting an IPv4 public network address from the network side; and
routing IPv4 packets for IPv4 client devices using an IPv4 public network address allocated by the network side.

3. The gateway according to claim 1, wherein the processor is further configured to execute the instruction stored in the memory to cause the gateway to execute the following operations:
periodically detecting whether the unavailable DS-Lite tunnel is restored to be available; and
switching the working mode from the second mode to the first mode when the DS-Lite tunnel is restored to be available.

4. The gateway according to claim 3, wherein the processor is further configured to execute the instruction stored in the memory to cause the gateway to execute the following operation:
releasing the IPv4 public network address used in the second mode after switching the working mode from the second mode to the first mode.

5. The gateway according to claim 1, wherein the gateway uses an IPv6 public network address to route IPv6 packets for IPv6 client devices in each of the first mode and the second mode.

6. The gateway according to claim 1, wherein the processor is further configured to execute the instruction stored in the memory to cause the gateway to execute the following operation:
determining that the DS-Lite tunnel is unavailable based on determining that the establishment of the DS-Lite tunnel fails.

7. The gateway according to claim 1, wherein the processor is further configured to execute the instruction stored in the memory to cause the gateway to execute the following operation:
determining that the DS-Lite tunnel is unavailable based on not receiving a packet from the AFTR device within a predetermined time.

8. A method for routing packets, including:
establishing a DS-Lite tunnel with an AFTR device by a gateway to work in a first mode, wherein the gateway can work in a working mode including a first mode and a second mode, the gateway uses the DS-Lite tunnel to route IPv4 packets for IPv4 client devices in the first mode, and the gateway uses its IPv4 public network address to route IPv4 packets for IPv4 client devices in the second mode; and
in response to determining that the DS-Lite tunnel is unavailable, switching the working mode from the first mode to the second mode by the gateway.

9. The method according to claim 8, wherein switching the working mode from the first mode to the second mode by the gateway includes:
requesting an IPv4 public network address from the network side by the gateway; and
routing IPv4 packets for IPv4 client devices by the gateway using an IPv4 public network address allocated by the network side.

10. The method according to claim 8, further including:
periodically detecting by the gateway whether the unavailable DS-Lite tunnel is restored to be available; and
switching the working mode from the second mode to the first mode by the gateway when the DS-Lite tunnel is restored to be available.

11. The method according to claim 10, further including:
releasing the IPv4 public network address used in the second mode by the gateway after switching the working mode from the second mode to the first mode.

12. The method according to claim 8, wherein the gateway uses an IPv6 public network address to route IPv6 packets for IPv6 client devices in each of the first mode and the second mode.

13. The method according to claim 8, wherein determining that the DS-Lite tunnel is unavailable includes:
determining by the gateway that the DS-Lite tunnel is unavailable based on determining that the establishment of the DS-Lite tunnel fails.

14. The method according to claim 8, wherein determining that the DS-Lite tunnel is unavailable includes:
determining by the gateway that the DS-Lite tunnel is unavailable based on not receiving a packet from the AFTR device within a predetermined time.

15. A non-transitory computer-readable medium having an instruction stored therein, when executed by a processor, the instruction causing the processor to execute operations including the following:
establishing a DS-Lite tunnel with an AFTR device to work in a first mode, wherein the gateway can work in a working mode including a first mode and a second mode, the gateway uses the DS-Lite tunnel to route IPv4 packets for IPv4 client devices in the first mode, and the gateway uses its IPv4 public network address to route IPv4 packets for IPv4 client devices in the second mode; and
in response to determining that the DS-Lite tunnel is unavailable, switching the working mode from the first mode to the second mode by the gateway.

16. The non-transitory computer-readable medium according to claim 15, wherein, when executed by the processor, the instruction causes the processor to further execute operations including the following:
requesting an IPv4 public network address from the network side; and
routing IPv4 packets for IPv4 client devices using an IPv4 public network address allocated by the network side.

17. The non-transitory computer-readable medium according to claim 15, wherein, when executed by the processor, the instruction causes the processor to further execute operations including the following:
periodically detecting whether the unavailable DS-Lite tunnel is restored to be available; and
switching the working mode from the second mode to the first mode when the DS-Lite tunnel is restored to be available.

18. The non-transitory computer-readable medium according to claim 17, wherein, when executed by the processor, the instruction causes the processor to further execute operations including the following:
releasing the IPv4 public network address used in the second mode after switching the working mode from the second mode to the first mode.

19. The non-transitory computer-readable medium according to claim 15, wherein, when executed by the processor, the instruction causes the processor to further execute operations including the following:
determining that the DS-Lite tunnel is unavailable based on determining that the establishment of the DS-Lite tunnel fails; and/or
determining that the DS-Lite tunnel is unavailable based on not receiving a packet from the AFTR device within a predetermined time.

20. (canceled)
